(19) United States
(12) Patent Application Publication
(10) Pub. No.: US 2016/0237255 A1
(43) Pub. Date: Aug. 18, 2016

(54) RUBBER COMPOSITION AND PNEUMATIC TIRE

(71) Applicant: The Goodyear Tire & Rubber Company, Akron, OH (US)

(72) Inventors: Dan Qu, Akron, OH (US); Arindam Mazumdar, Stow, OH (US); Frank James Feher, Copley, OH (US)

(21) Appl. No.: 15/137,166

(22) Filed: Apr. 25, 2016

Related U.S. Application Data
(62) Division of application No. 14/294,655, filed on Jun. 3, 2014.
(60) Provisional application No. 61/912,061, filed on Dec. 5, 2013.

(51) Int. Cl. C08L 7/02; C08J 3/00

(52) U.S. Cl. CPC C08L 7/02; C08J 3/005; C08J 2307/02; C08J 2461/12

(57) ABSTRACT

The present invention is directed to a rubber composition comprising a diene based elastomer comprising a functional group selected from the group consisting of hydroxyl, primary amine, and secondary amine; and a binding agent selected from the group consisting of water-dispersible resin, polyelectrolytes, and polypeptides. The invention is further directed to a pneumatic tire including the rubber composition, and a method of increasing the green strength in a rubber composition.

### BACKGROUND

Science and technology in the elastomer field has developed to such an extent that synthetic elastomers have supplemented or replaced natural rubber to a great extent in the fabrication of tires and other rubber products. However, a major deficiency of synthetic elastomers is the lack of sufficient green strength required for satisfactory processing or building properties as in building tires. The abatement of this deficiency has long been sought by the art.

The term “green strength,” while being commonly employed and generally understood by persons skilled in the rubber industry, is nevertheless a difficult property to precisely define. Basically, it is that property of an unvulcanized polymer common in natural rubber which, under normal building conditions where multiple components are employed, results in little or no unwanted distortion of any of the assembled components. Thus, with synthetic polymers or copolymers, adequate green strength, that is the requisite mechanical strength for processing and fabricating operations necessarily carried out prior to vulcanization, is lacking. That is, generally the maximum or “peak” stress which the unvulcanized materials will exhibit during deformation is rather low. Thus, unvulcanized strips or other forms of the elastomer are often distorted during processing or building operations. Although numerous additives and compounds have been utilized in association with various elastomers, substantial improvement in green strength has generally not been accomplished.

Green strength has generally been measured by stress/strain curves of unvulcanized compounds. Usually, the green strength of a compound is indicated by various properties of the stress/strain curve; typically, the average slope beyond the first peak or inflection of the curve, the (ultimate) tensile strength, and the ultimate elongation. Improvements in any one or more of these stress properties indicate improved green strength.

### SUMMARY

The present invention is directed to a rubber composition comprising

a diene based elastomer comprising a functional group selected from the group consisting of hydroxyl, primary amine, and secondary amine; and

a binding agent selected from the group consisting of water-dispersible resin, polyelectrolytes, and polypeptides.

The invention is further directed to a pneumatic tire comprising the rubber composition.

The invention is further directed to a method of increasing the green strength of a rubber composition.

### BRIEF DESCRIPTION OF THE DRAWINGS

FIG. 1 shows a graph stress versus strain for several uncured Hevea natural rubber samples containing a resin.

FIG. 2 shows a graph of crystallinity versus strain for several uncured Hevea natural rubber samples containing a resin.

FIG. 3 shows a graph stress versus strain for several uncured deproteinized Hevea natural rubber samples containing a resin.

FIG. 4 shows a graph of crystallinity versus strain for several uncured deproteinized Hevea natural rubber samples containing a resin.

FIG. 5 shows a graph stress versus strain for several cured Hevea natural rubber samples containing a resin.

FIG. 6 shows a graph of crystallinity versus strain for several cured Hevea natural rubber samples containing a resin.

FIG. 7 shows a graph stress versus strain for several cured Hevea natural rubber samples containing a resin and carbon black.

FIG. 8 shows a graph of crystallinity versus strain for several cured Hevea natural rubber samples containing a resin and carbon black.

FIG. 9 shows a graph stress versus strain for several uncured guayule rubber samples containing a resin.

FIG. 10 shows a graph of crystallinity versus strain for an uncured guayule rubber sample containing a resin.

### DESCRIPTION

There is disclosed a rubber composition comprising

a diene based elastomer comprising a functional group selected from the group consisting of hydroxyl, primary amine, and secondary amine; and

a binding agent selected from the group consisting of water-dispersible resin, polyelectrolytes, and polypeptides.

There is further disclosed a pneumatic tire comprising the rubber composition.

There is further disclosed a method of increasing the green strength of a rubber composition.

The rubber composition includes a diene based elastomer comprising a functional group selected from the group consisting of hydroxyl, primary amine, and secondary amine. Suitable diene based elastomers include natural rubber, synthetic polyisoprenes, polybutadienes, styrene-butadiene rubbers, styrene-isoprene-butadiene rubbers, isoprene-butadiene rubbers, and the like.

In one embodiment, the diene based elastomer comprising a functional group is a hydroxyl-functionalized elastomer, such as polyisoprene (although other diene based elastomers may be analogously functionalized). Suitable polyisoprenes include natural and synthetic polyisoprenes. Natural polyisoprene include those such as those from rubber trees (Hevea Brasiliensis), guayule shrub (Parthenium argentatum) and Russian dandelion (Taraxacum kok-saghyz). Suitable functionalized synthetic polyisoprene include end functionalized hydroxyl-polyisoprenes produced for example via ethylene oxide termination of the anionic polymer polymerization with a lithium catalyst, for example. Chain functionalized hydroxyl-polyisoprene produced for example via epoxidation can be obtained by reacting a diene copolymer with hydrogen peroxide or 3-chloroperoxy benzoic acid (refer to WO97/02296, WO98/28338, Japanese Patent Publication Hei 10-1564 and Polymer, 1987, 28, 1977), followed by ring opening of the epoxide. Alternatively, chain functionalized hydroxyl-polyisoprene can be obtained by dissolving the diene based elastomer in organic solvents and then reducing the resulting solution with metal hydride such as LiAlH₄ (refer to Polymer, 1987, 28, 1977).

In one embodiment, diene based elastomer comprising a functional group is a primary or secondary amine-functionalized elastomer, such as polyisoprene (although other diene based elastomers may be analogously functionalized). Suitable functionalized synthetic polyisoprene include end functionalized amino-polyisoprenes produced for example via amine termination of the anionic polymer polymerization with a lithium catalyst, for example. Chain functionalized amino-polyisoprene produced for example via epoxidation can be obtained by reacting a diene copolymer with hydrogen peroxide or 3-chloroperoxy benzoic acid (refer to WO97/02296, WO98/28338, Japanese Patent Publication Hei 10-1564 and Polymer, 1987, 28, 1977). Ring opening of the epoxide to obtain primary amine functionalized elastomer may be achieved with aqueous ammonia in the presence of organic co-solvents (refer to Pasto et al., Tetrahedron Letters 44 (2003) 8369-8372). Alternatively, ring opening of the epoxide to obtain secondary amine functionalized elastomer may be achieved for example by reaction with β-naphthylamine in the presence of phenol catalyst under argon atmosphere (refer to Kirpichev et al., Rubber Chemistry and Technology: September 1970, Vol. 43, No. 5, 1225-1229), or reaction with 4-aniloaniline in toluene with phenol catalysis (refer to Jayawardena et al., Makromol. Chem. 185, 2089-2097 (1984)).

Suitable polyisoprene will have a number average molecular weight ranging from 50,000 to 2,000,000, as determined by methods as are known in the art. In one embodiment, the polyisoprene will have a number average molecular weight ranging from 100,000 to 1,000,000.

The rubber composition further includes a binding agent selected from the group consisting of water-dispersible resin, polyelectrolytes, and polypeptides. By water dispersible, it is meant that the resin may be dispersed or emulsified in an aqueous mixture of water, the resin, and any required dispersing or emulsifying agents.

Suitable water dispersible resins include methylene donor/methylene acceptor resins and phenol/formaldehyde resins.

In one embodiment, the water dispersible resin is the reaction product of a methylene acceptor and a methylene donor.

Methylene acceptor/methylene donor resins involve the reaction of a methylene acceptor and a combination methylene donor. The term “methylene donor” is intended to mean a chemical capable of reacting with a methylene acceptor and generate the resin in-situ.

Examples of methylene donors which are suitable for use in the present invention include hexamethylenetetramine, and N-substituted oxymethylmelamines, of the general formula:

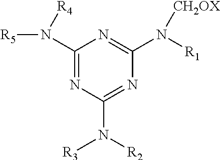

wherein X is hydrogen or an alkyl having from 1 to 8 carbon atoms, R₁, R₂, R₃, R₄ and R₅ are individually selected from the group consisting of hydrogen, an alkyl having from 1 to 8 carbon atoms, the group —CH₂OX or their condensation products. Specific methylene donors include hexakis-(methoxymethyl)melamine, N,N′,N″-trimethyl/N,N′,N″-trimethylolmelamine, hexamethylolmelamine, N,N′,N″-dimethylolmelamine, N-methylolmelamine, N,N′-dimethylolmelamine, N,N′,N″-tris(methoxymethyl)melamine, N,N′N″-tributyl-N,N′,N″-trimethylol-melamine, hexamethoxymethylmelamine, and hexaethoxymethylmelamine. The N-methylol derivatives of melamine are prepared by known methods.

The amount of methylene donor used to produce the resin may vary. In one embodiment, the amount of methylene donor ranges from 1 to 10 phr. In another embodiment, the amount of methylene donor ranges from 1 to 10 phr.

The term “methylene acceptor” is known to those skilled in the art and is used to describe the reactant to which the methylene donor reacts to form what is believed to be a methylol monomer. The condensation of the methylol monomer by the formation of a methylene bridge produces the resin. The initial reaction that contributes the moiety that later forms into the methylene bridge is the methylene donor wherein the other reactant is the methylene acceptor. Representative compounds which may be used as a methylene acceptor include but are not limited to resorcinol, resorcinolic derivatives, monohydric phenols and their derivatives, dihydric phenols and their derivatives, polyhydric phenols and their derivatives, unmodified phenol novolak resins, modified phenol novolak resin, resorcinol novolak resins and mixtures thereof. Examples of methylene acceptors include but are not limited to those disclosed in U.S. Pat. No. 6,605,670; U.S. Pat. No. 6,541,551; U.S. Pat. No. 6,472,457; U.S. Pat. No. 5,945,500; U.S. Pat. No. 5,936,056; U.S. Pat. No. 5,688,871; U.S. Pat. No. 5,665,799; U.S. Pat. No. 5,504,127; U.S. Pat. No. 5,405,897; U.S. Pat. No. 5,244,725; U.S. Pat. No. 5,206,289; U.S. Pat. No. 5,194,513; U.S. Pat. No. 5,030,692; U.S. Pat. No. 4,889,481; U.S. Pat. No. 4,605,696; U.S. Pat. No. 4,436,853; and U.S. Pat. No. 4,092,455. Examples of modified phenol novolak resins include but are not limited to cashew nut oil modified phenol novolak resin, tall oil modified phenol novolak resin and alkyl modified phenol novolak resin. In one embodiment, the methylene acceptor is resorcinol.

Other examples of methylene acceptors include activated phenols by ring substitution and a cashew nut oil modified novalak-type phenolic resin. Representative examples of activated phenols by ring substitution include resorcinol, cresols, t-butyl phenols, isopropyl phenols, ethyl phenols and mixtures thereof. Cashew nut oil modified novolak-type phenolic resins are commercially available from Schenectady Chemicals Inc under the designation SP6700. The modification rate of oil based on total novolak-type phenolic resin may range from 10 to 50 percent. For production of the novolak-type phenolic resin modified with cashew nut oil, various processes may be used. For example, phenols such as phenol, cresol and resorcinol may be reacted with aldehydes such as formaldehyde, paraformaldehyde and benzaldehyde using acid catalysts. Examples of acid catalysts include oxalic acid, hydrochloric acid, sulfuric acid and p-toluenesulfonic acid. After the catalytic reaction, the resin is modified with the oil.

The amount of methylene acceptor used to produce the resin may vary. In one embodiment, the amount of methylene acceptor ranges from 1 to 10 phr. In another embodiment, the amount of methylene acceptor ranges from 1 to 10 phr.

In one embodiment, the water dispersible resin may be a phenol-formaldehyde type resin. This reaction product is the result of a condensation reaction between a hydroxyl group on the phenol such as resorcinol and the aldehyde group on the formaldehyde. Other suitable phenols include resorcinolic derivatives, monohydric phenols and their derivatives, dihydric phenols and their derivatives, polyhydric phenols and their derivatives.

The resorcinol may be dissolved in water to which around 37 percent formaldehyde has been added together with a strong base such as sodium hydroxide. The strong base should generally constitute around 7.5 percent or less of the resorcinol, and the molar ratio of the formaldehyde to resorcinol should be in a range of from about 1.5 to about 2.

The aqueous solution of the resole or condensation product or resin is mixed with a latex of the hydroxyl-functionalized polyisoprene. A latex of synthetic polyisoprene may be produced as described in U.S. Pat. No. 8,163,838. Alternatively, the latex may be a natural latex as extracted from the hevea tree or guayule plant, for example.

The resole or other mentioned condensation product or materials that form said condensation product should constitute from 1 to 10 parts and preferably around 3 to 7 parts by solids of the latex mixture. The condensation product forming the resole or resole type resin forming materials should preferably be partially reacted or reacted so as to be only partially soluble in water. The weight ratio of the resorcinol/formaldehyde resin to the elastomer from the latex should be in a range of from 0.005 to 0.2, alternatively 0.01 to about 0.1, alternatively in a range of from 0.04 to 0.01.

It is normally preferable to first prepare the polymer latex and then add the partially condensed condensation product. However, the ingredients (the resorcinol and formaldehyde) can be added to the polymer latex in the uncondensed form and the entire condensation can then take place in situ. The latex tends to keep longer and be more stable if it is kept at an alkaline pH level.

The aqueous mixture of resin and hydroxyl-polyisoprene is treated with a suitable coagulant such as alum, calcium chloride, and the like, to coagulate the solids to isolate the composite solid of hydroxy-polyisoprene and water dispersible resin. The solids are then filtered, dried and compounded as desired in the rubber composition.

Uniquely as compared to conventional RFL (resorcinol-formaldehyde-latex) compositions, the present composition is not used as an adhesive treatment on fiber or cord reinforcement. Typically, aqueous RFL treatments are used to dip reinforcement fiber cords to enhance adhesion of the reinforcement to rubber. Instead, the present rubber composition is separated from the water to isolate the solid resin/elastomer composite. The isolated composite is then combined with desired compounding additives as will be described. In one embodiment then, the rubber composition excludes fiber or cord reinforcement.

Polyelectrolytes suitable as binding agents include but are not limited to polyelectrolytes with opposite charge of the elastomer functional groups and/or the surface charge groups or polyampholytes. Examples of such polyelectrolytes are poly(allylamine hydrochloride), polyallylamine, chitosan, poly(diallyldimethylammonium chloride), poly(styrene-sulfonate), poly(acrylic acid), and the like.

Polypeptides suitable for use as binding agents include but are not limited to natural polypeptides such as whey protein isolate and vegetable protein isolate, and synthetic polypeptides such as polyglutamates.

The rubber composition may include at least one additional diene based rubber. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are natural rubber, synthetic polyisoprene, polybutadiene and SBR.

In one aspect the additional rubber is preferably of at least two of diene based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

In one aspect of this invention, an emulsion polymerization derived styrene/butadiene (E-SBR) might be used as an additional rubber having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, cis 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

In one embodiment, cis 1,4-polybutadiene rubber (BR) is used as an additional rubber. Suitable polybutadiene rubbers may be prepared, for example, by organic solution polymerization of 1,3-butadiene. The BR may be conveniently characterized, for example, by having at least a 90 percent cis 1,4-content and a glass transition temperature Tg in a range of from −95 to −105° C. Suitable polybutadiene rubbers are available commercially, such as Budene® 1207 from Goodyear and the like.

In one embodiment, a synthetic or natural polyisoprene rubber may be used.

A reference to glass transition temperature, or Tg, of an elastomer or elastomer composition, where referred to herein, represents the glass transition temperature(s) of the respective elastomer or elastomer composition in its uncured state or possibly a cured state in a case of an elastomer composition. A Tg can be suitably determined as a peak midpoint by a differential scanning calorimeter (DSC) at a temperature rate of increase of 10° C. per minute.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 10 to about 100 phr of silica.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 100 phr. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), crosslinked particulate polymer gels including but not limited to those disclosed in U.S. Pat. No. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. Examples of suitable sulfur containing organosilicon compounds are of the formula:

Z-Alk-Sₙ-Alk-Z I

in which Z is selected from the group consisting of

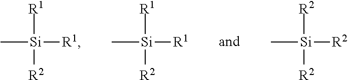

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide. Therefore, as to formula I, Z may be

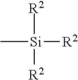

where R² is an alkoxy of 2 to 4 carbon atoms, alternatively 2 carbon atoms; alk is a divalent hydrocarbon of 2 to 4 carbon atoms, alternatively with 3 carbon atoms; and n is an integer of from 2 to 5, alternatively 2 or 4.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the component is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

In so building a tire, the rubber composition is used in a method of increasing the green strength of a rubber composition. That is, the rubber composition combining the functionalized elastomer and the binding agent may exhibit strain induced crystallization, which is indicative of superior green strength in a rubber compound desirable during tire building.

The invention is further illustrated by the following non-limiting examples.

### Materials

High ammonia NR latex (60.38 wt % dry rubber content, pH=10.23) was acquired from Von Bundit Co. Ltd. in Thailand. Guayule NR latex (65 wt % dry rubber content) was acquired from Professor Katrina Cornish at Ohio State University. Formaldehyde solution was from EMD Chemicals Inc. (FX0410-1, ACS grade).

### Tensile Measurements

Stress-strain relationship was measured with a Uniaxel Tensile Tester (Instron Model 8511). A micro-sample loader was used for small size samples. The gauge length of the dumbbell samples was ˜30 mm. The measurements were conducted at 23° C. with a strain rate of 10% per second, equivalent to ˜3 mm/s.

In-Situ Synchrotron X-Ray Scattering with Tensile Measurements

Synchrotron X-ray measurements were carried out at the X27C beam line in the National Synchrotron Light Source (NSLS), Brookhaven National Laboratory (BNL). The beam wavelength was 1.371 Å. Wide-Angle X-ray Diffraction (WAXD) was performed. Twodimensional WAXD patterns were acquired using a MAR-CCD detector with an image acquisition time of 30 seconds. Each X-ray measurement was performed non-stop and simultaneously with a stress-strain measurement when a dumbbell rubber sample was being pulled and then relaxed. The maximum strain was 640% and the strain rate was 10 mm/min. All measurements were carried out at room temperature.

### Nitrogen Content Measurement

Percent nitrogen (% N) analyses were performed on a Combustion CHNS Analyzer (Interscience Thermo Finnigan Flash EA 1112 Series) according to method QA5118-1. The results provided were the mean of two measurements.

### Example 1

Resorcinol-Formaldehyde resin (RF) master solution was made by mixing 37 weight percent formaldehyde solution, DI water, 10% NaOH solution and resorcinol solid according to the desired F/R (formaldehyde/resorcinol) weight ratio. The solid weight-ratio of NaOH to resorcinol was kept at 0.1. The total solid wt % of the master solution was kept at 6.9%. The RF master solution was left to mature for 4 hrs, to allow formaldehyde reaction with resorcinol. The RF solution was then mixed with the appropriate amount of NR latex and left to mature for 24 hrs. The RF Latex was then poured into a petri dish to dry at room temperature in a ventilation hood for about 3 days, during which the latex particle surfaces touch until the rubber was fully coagulated into a cast film.

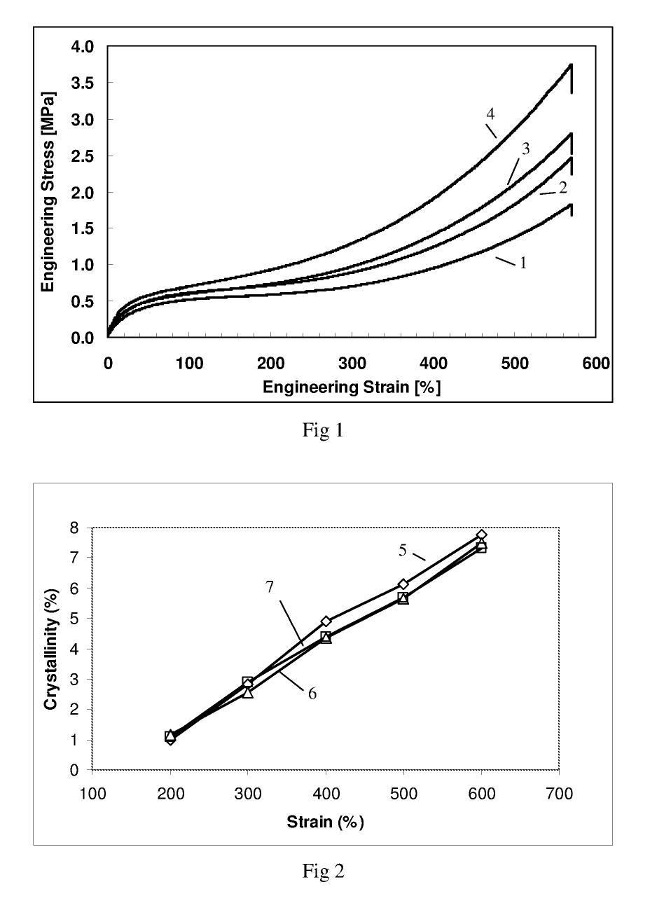

Cast film samples with three different F/R ratios: 1.1, 1.3 and 1.7, were fabricated and tested. The wt % of RF was also varied from 1 to 5 percent to show possible effects from different RF loading. FIG. 1 shows the tensile results and strain-induced crystallinity of the samples with F/R=1.3 as listed in Table 1. The labels of FIG. 1 (and all subsequent figures) indicate the sample number.

TABLE 1

| Sample No. | RF, weight % |
|---|---|
| 1 | 1 |
| 2 | 2 |
| 3 | 3 |
| 4 | 5 |

As seen in FIG. 1, for all RF contents, the tensile modulus increases with RF loading. Since no sample broke at the maximum strain of 600%, the green strength is not known. Similar results were seen for F/R=1.1 and 1.7.

FIG. 2 shows crystallinity data as determined by WAXD for samples having 3 weight percent RF as listed in Table 2. As seen in FIG. 2, F/R ratio in the range between 1.1 and 1.7 has little influence on the strain-induced crystallinity. This suggests that the coupling of F-R is complete after 4 hrs of maturation, and the residual resorcinol molecules do not have significant effect on the final cast film, except for leaving more resorcinol aggregates. Similar results were seen for RF contents of 1, 2 and 5 weight percent.

TABLE 2

| Sample No. | F/R |
|---|---|
| 5 | 1.1 |
| 6 | 1.3 |
| 7 | 1.7 |

### Example 2

Deproteinized natural rubber was produced by centrifuging NR latex. This method can remove most of the soluble proteins in the latex suspension. Centrifugation was performed on a RC5C Automatic Superspeed Refrigerated Centrifuge (Sorvall Instruments) with rotor SA600 (Code 4). One centrifugation cycle was performed. High ammonia Hevea NR latex was diluted to 30 wt % and centrifuged at 9000 rpm for 45 min. NR deproteinized by centrifugation was labeled DPNR.

Samples of deproteinized Hevea NR were characterized for nitrogen content with results as shown in Table 3.

TABLE 3

| Rubber Type | Nitrogen, weight % | % of proteins removed |
|---|---|---|
| Hevea NR | 0.33 | 0 |
| DPNR | 0.20 | 40% |

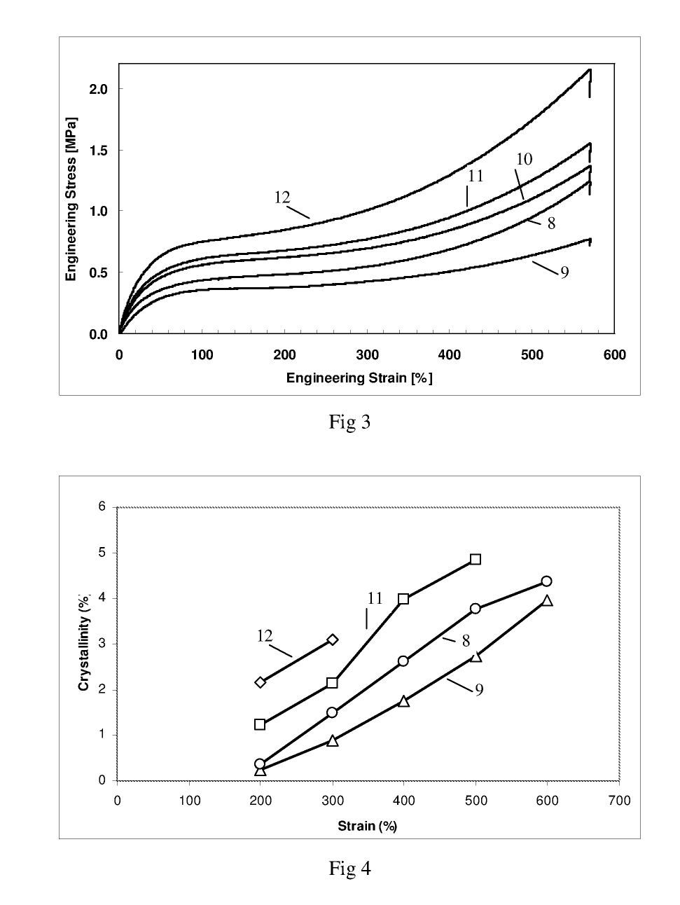

Cast films of deproteinized natural rubber latex were prepared as described in Example 1. FIG. 3 shows the tensile modulus of DPNR cast films after various wt % of RF additions for the sample as listed in Table 4 (Formaldehyde/Resorcinol F/R=1.7). FIG. 4 shows strain induced crystallinity increase in DPNR cast film after different wt % RF additions for the samples list in Table 4 (F/R=1.7). As seen in FIGS. 3 and 4, the modulus and the SIC decreases when protein is partially removed, but increases with the increases of RF wt % and greatly exceed those of Hevea NR without RF addition.

TABLE 4

| Sample No. | Rubber Type | RF, weight % |
|---|---|---|
| 8 | Hevea NR | 0 |
| 9 | DPNR | 0 |
| 10 | DPNR | 2 |
| 11 | DPNR | 3 |
| 12 | DPNR | 5 |

### Example 3

To determine whether the strengthening effect of RF could remain after curing, Hevea NR samples with different RF loading (at fixed F/R=1.7) were mixed and cured. The recipes are the same as listed in Tables 5 and 6, with amounts given in phr.

TABLE 5

| | |
|---|---|
| Natural Rubber-RF | 100 |
| Carbon Black | 0 or 30 |
| ZnO | 5 |
| Stearic Acid | 1 |
| Antidegradant | 2 |
| Sulfur | 2.6 |
| Sulfenamide | 1.4 |

The non-productive unit mixing lasted 4 minutes, with drop temperature between 150° C. and 170° C. The productive mixing lasted 3 minutes with drop temperature between 90° C. and 100° C. Curing was done at 150° C. for 15 minutes.

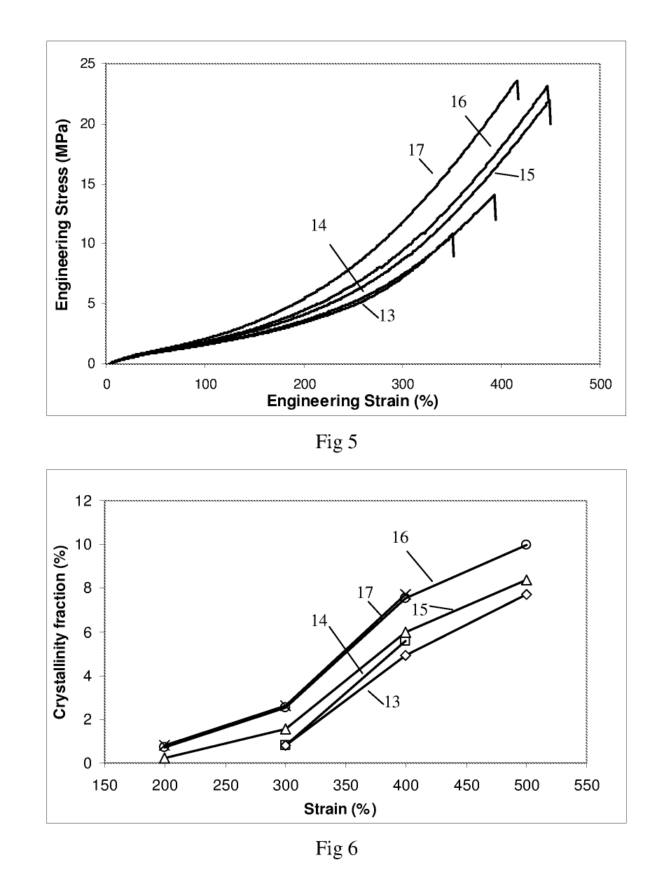

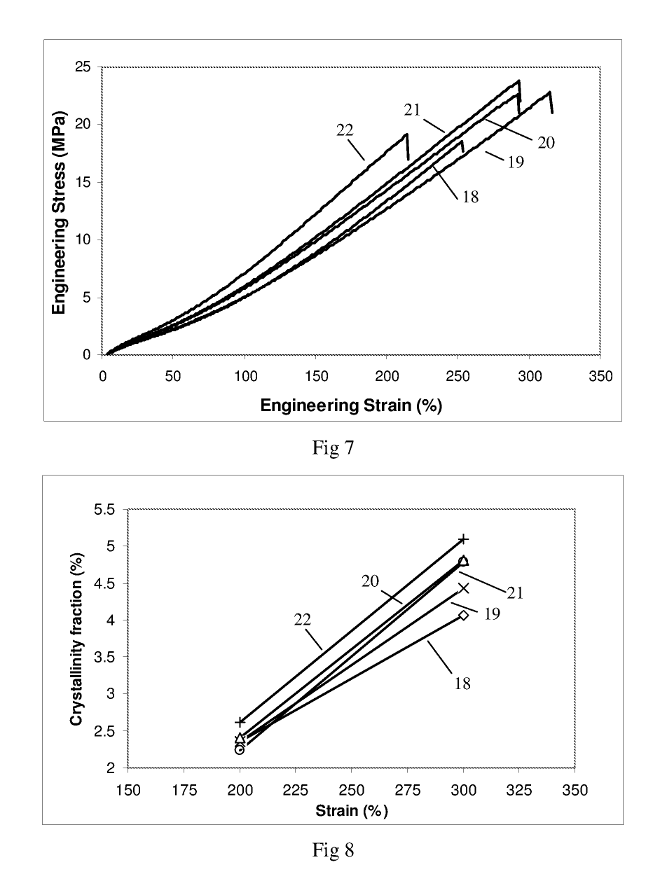

FIGS. 5 (no carbon black) and 7 (with 30 phr carbon black) show the tensile modulus of the 1 wt %, 2 wt %, 3 wt % and 5 wt % RF-modified Hevea NR cast films. FIGS. 6 and 8 show the crystallinity of these samples. The cured samples, especially those with carbon black, broke at a lower strain level than the uncured samples (compare FIG. 1). However, the tensile strength is comparable with or without carbon black. The 1 wt % RF-modified samples had tensile modulus close to that of NR samples without RF, but with higher tensile strength. Once RF is loaded, the increase in RF loading augments the tensile modulus but not the tensile strength. Increase in RF loading also increases significantly the strain induced crystallization (SIC), as is shown in FIGS. 6 and 8. This is observed both with and without carbon black.

TABLE 6

| Sample No. | Carbon Black, phr | RF, weight % |
|---|---|---|
| 13 | 0 | 0 |
| 14 | 0 | 1 |
| 15 | 0 | 2 |
| 16 | 0 | 3 |
| 17 | 0 | 5 |
| 18 | 30 | 0 |
| 19 | 30 | 1 |
| 20 | 30 | 2 |
| 21 | 30 | 3 |
| 22 | 30 | 5 |

### Example 4

In this example, the effect of RF addition on a non-crystallizing elastomer is demonstrated. Guayule natural rubber latex contains only cis-1,4 PI chains but shows poor tensile modulus and no SIC at room temperature. Reportedly the chains contain only —OH termination groups. The following section presents the influence of surface binding on the tensile modulus and SIC of Guayule latex cast films.

Cast films samples were produced using Guayule latex in the manner described in Example 1.

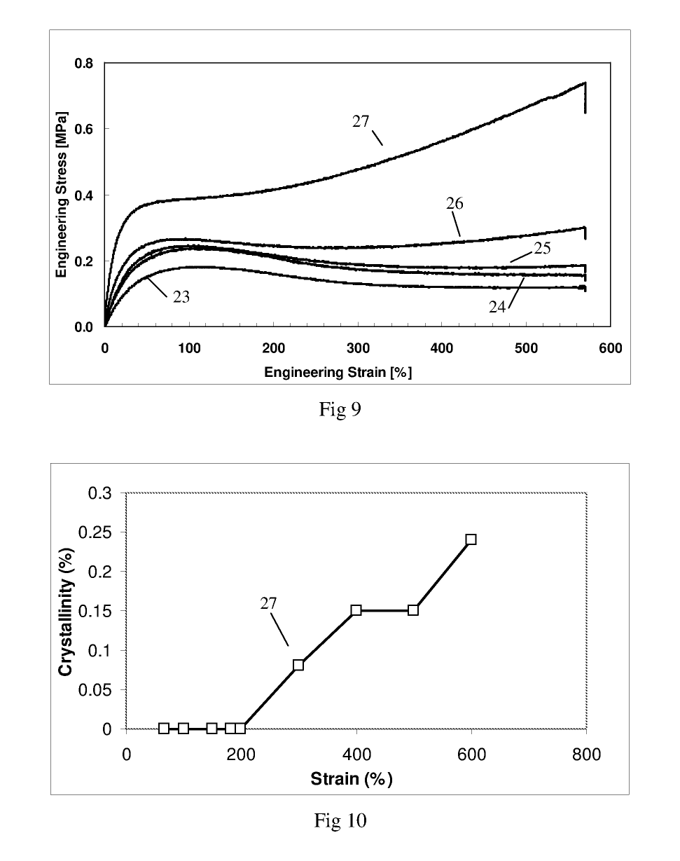

As shown FIG. 9, the tensile modulus increases with increasing loading of RF and has a significant jump at 5 wt % RF loading, comparing Guayule and RF-Guayule cast films (F/R=1.7) for the sample as listed in Table 7. This increase in modulus suggests network formation surface interactions of the polymer with the resin.

TABLE 7

| Sample No. | RF, weight % |
|---|---|
| 23 | 0 |
| 24 | 1 |
| 25 | 2 |
| 26 | 3 |
| 27 | 5 |

Further evidence of such network formation is shown in FIG. 10. As seen in FIG. 10, WAXD data shows that except for the case of 5 wt % RF loading, no SIC was observed. However, in the case of 5 wt % RF loading, a weak SIC was observed. Correspondingly, at 5 wt % RF loading, the tensile curve in FIG. 9 shows an upturn as the strain increases, a signature of SIC in Hevea NR.

While certain representative embodiments and details have been shown for the purpose of illustrating the invention, it will be apparent to those skilled in this art that various changes and modifications may be made therein without departing from the spirit or scope of the invention.

What is claimed is:

1-11. (canceled)

12. A method of increasing the green strength of a rubber composition, comprising the steps of:
mixing a diene based elastomer latex with an aqueous dispersion of a binding agent selected from the group consisting of water-dispersible resin, polyelectrolytes, and polypeptides, to form a mixture comprising solids and liquid, wherein the diene based elastomer comprises a functional group selected from the group consisting of hydroxyl, primary amine, and secondary amine; and
separating the solids from the liquid to obtain a solid composite.

13. The method of claim 12, where the diene based elastomer is selected from synthetic polyisoprene, natural polyisoprene, and polybutadiene.

14. The method of claim 12, wherein the diene based elastomer is a hydroxyl functionalized polyisoprene.

15. The method of claim 12, wherein the binding agent is a water-dispersible resin selected from the group consisting of resorcinol-formaldehyde resins and resorcinolmelamine resins.

16. The method of claim 15, wherein the water-dispersible resin is a resorcinol formaldehyde resin.

17. The method of claim 14, wherein the hydroxyl-functionalized polyisoprene has a number average molecular weight ranging from 50000 to 2000000.

18. The method of claim 14, wherein the hydroxyl-functionalized polyisoprene is derived from a synthetic polyisoprene or a natural polyisoprene.

19. The method of claim 14, wherein the weight ratio of the water-dispersible resin to elastomer ranges from 0.005 to 0.2.

20. The method of claim 14, wherein the hydroxyl-functionalized polyisoprene is a guayule rubber.
